(19) United States
(12) Patent Application Publication
(10) Pub. No.: US 2018/0005534 A1
(43) Pub. Date: Jan. 4, 2018

(54) AUTONOMOUS NAVIGATION OF AN UNMANNED AERIAL VEHICLE

(71) Applicant: Sharp Laboratories of America, Inc., Camas, WA (US)

(72) Inventors: Basil Isaiah JESUDASON, Portland, OR (US); Ahmet Mufit FERMAN, Vancouver, WA (US)

(21) Appl. No.: 15/198,700

(22) Filed: Jun. 30, 2016

(51) Int. Cl. G08G 5/00; B64D 47/08; B64C 39/02; G05D 1/10; G05D 1/00

(52) U.S. Cl. CPC G08G 5/0069; G05D 1/101; G05D 1/0011; B64C 39/024; B64D 47/08; B64C 2201/208

(57) ABSTRACT

A system for autonomous navigation of an unmanned aerial vehicle.

### CROSS-REFERENCE TO RELATED APPLICATIONS

Not applicable.

### BACKGROUND OF THE INVENTION

The present invention generally relates to an unmanned aerial vehicle, and in particular to autonomous navigation of an unmanned aerial vehicle.

To monitor extended geographic areas, a video imaging device and/or a camera imaging device, generally referred to as an imaging device may be mounted to an elevated platform. The platform may be, for example, a tower, a telephone pole, a bridge, or other fixed structures. While fixed structures tend to provide a wide view of a geographic area, they tend to be limited in the geographic area that is monitored. Other types of platforms may include a piloted aircraft, an unmanned aerial vehicle (UAV), and a dirigible all of which tend to be movable. The movable platforms tend to provide a greater geographic area that may be monitored. The movable platform may be controlled by a manned or unmanned ground based control platform, such as a vehicle, a boat, an operator in a control room, or otherwise. As a result of the monitoring, still images and/or video images may be sensed by the imaging device. In particular, for the still images and/or video images a continuous series of images may be provided to the ground based control platform using a receiver and a transmitter between the ground based control platform and the imaging device. The images may be captured at any suitable wavelengths, such as an infrared spectrum, a visible spectrum, an ultraviolet spectrum, and/or otherwise.

The images captured by the imaging device may be a scene within the field of view of the imaging device. To increase the field of view captured by the imaging device, the imaging device may be moved in its orientation to capture images of a different field of view. For example, an imaging device mounted on an unmanned aerial vehicle may be directed at a different field of view by adjusting the tilt and/or the pan of the unmanned aerial vehicle.

An operator at a remote location may operate the imaging device and/or the platform by use of a wireless remote-control system at the ground based control platform. In other cases, the ground based control platform may operate the imaging device and/or the platform by use of a wireless remote control system. However, the maneuverability of an unmanned aerial vehicle tends to be restricted due to the weight of the vehicle and its associated control system, therefore limiting the effectiveness of the unmanned aerial vehicle to obtain suitable image content.

### BRIEF DESCRIPTION OF THE DRAWINGS

FIG. 1 illustrates an exemplary unmanned aerial vehicle.

FIG. 2 illustrates a block diagram of an airframe body of an unmanned aerial vehicle.

FIG. 3 illustrates a flight control system for an unmanned aerial vehicle.

FIG. 4 illustrates different levels of autonomy for an unmanned aerial vehicle.

FIG. 5 illustrates an unmanned ground vehicle and an unmanned aerial vehicle.

FIG. 6 illustrates multiple unmanned ground vehicles and an unmanned aerial vehicle.

### DETAILED DESCRIPTION OF PREFERRED EMBODIMENTS

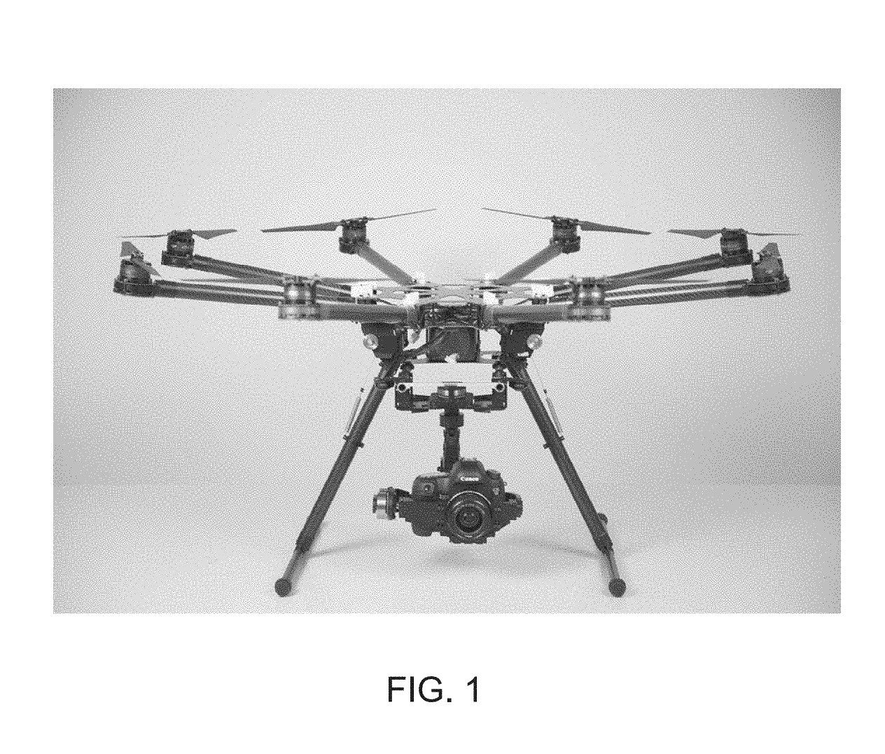

Referring to FIG. 1, a platform including an unmanned aerial vehicle (UAV) may include many different structures with each having a common element of not having a human pilot aboard. Often, UAVs are preferred for missions that are dull, dirty, dangerous, such as policing, surveillance, and aerial filming. Typically, the UAV is a powered aerial vehicle that does not carry a human operator while using aerodynamic forces to provide lift for the vehicle. For example, the UAV may include one or more rotating blades and/or one or more wings.

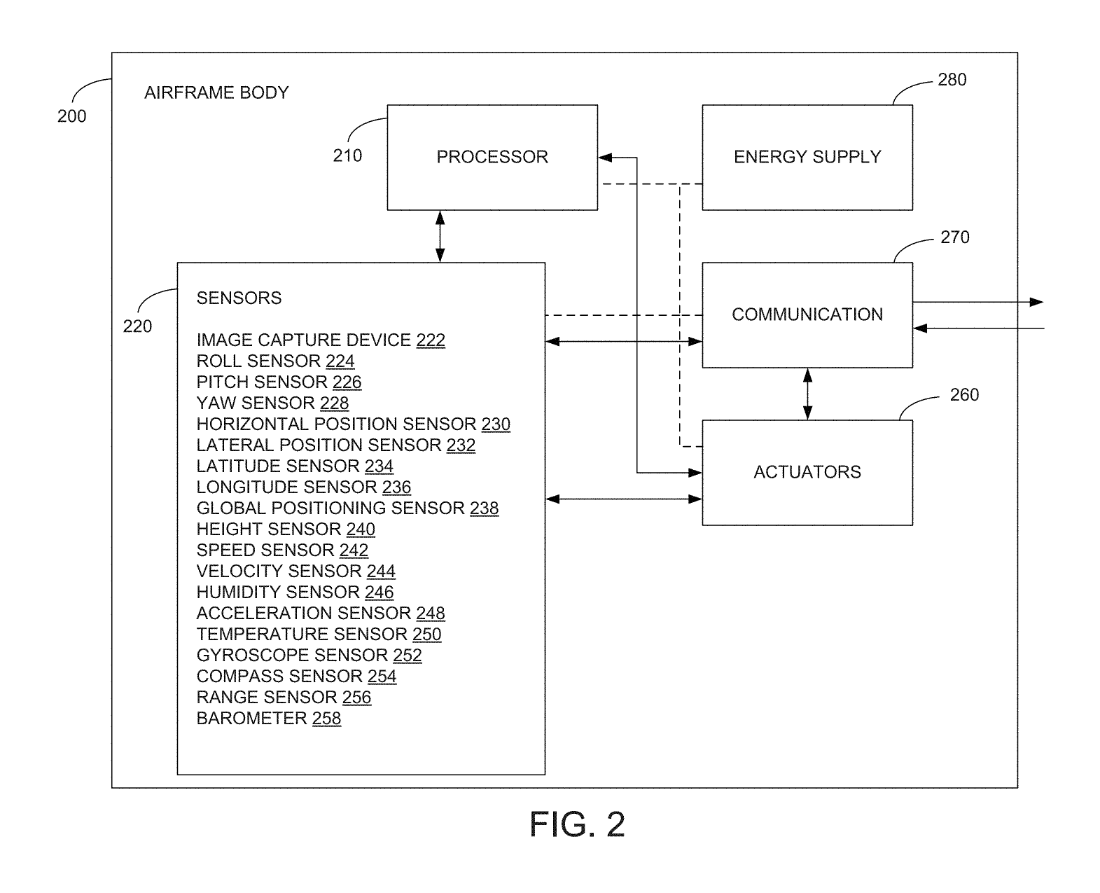

Referring also to FIG. 2, the UAV may include an airframe body 200 to support the other components thereon. The body 200 may support rotators and/or wings so that the UAV may take flight. The electronics of the airframe body 200 may include a processor 210 with one or more computing devices together with memory, to control other aspects of the UAV. The airframe body 200 may also include one or more sensors 220. The sensors may include, for example, image capture devices 222, a roll sensor 224, a pitch sensor 226, a yaw sensor 228, a horizontal position sensor 230, a lateral position sensor 232, a latitude sensor 234, a longitude sensor 236, a global positioning sensor 238, a height sensor 240, a speed sensor 242, a velocity sensor 244, a humidity sensor 246, an acceleration sensor 248, a temperature sensor 250, a gyroscope sensor 252, a compass sensor 254, a range sensor 256 (e.g., radar, sonar, lidar), a barometer sensor 258, etc. The sensors 220 may provide signals to the processor 210 and may receive signals from the processor, and the sensors 220 may provide and receive signals among the different sensors 220. The airframe body 200 may include a plurality of actuators 260. The actuators 260 may receive signals from the processor 210, one or more of the sensors 220, and/or one or more of the other actuators 260. The actuators 260 provide controls to the motors, engines, propellers, servomotors, weapons, payload actuators, lighting, speakers, ailerons, rudder, flaps, etc. In this manner, different devices of the airframe body 200 may be controlled. A communication module 270 may be used to receive signals, such as wireless signals from a ground based control platform, and to provide signals, such as wireless signals to a ground based control platform. An energy supply 280 may be used to provide power to all of the components of the airframe body 200. As it may be observed, many of the sensors 220 of the airframe body 200 tend to add weight to the airframe body 200 thereby reducing its maneuverability and increasing the complexity of the device, together with an increased likelihood of failure as a result of one or more of the sensors and/or actuators failing.

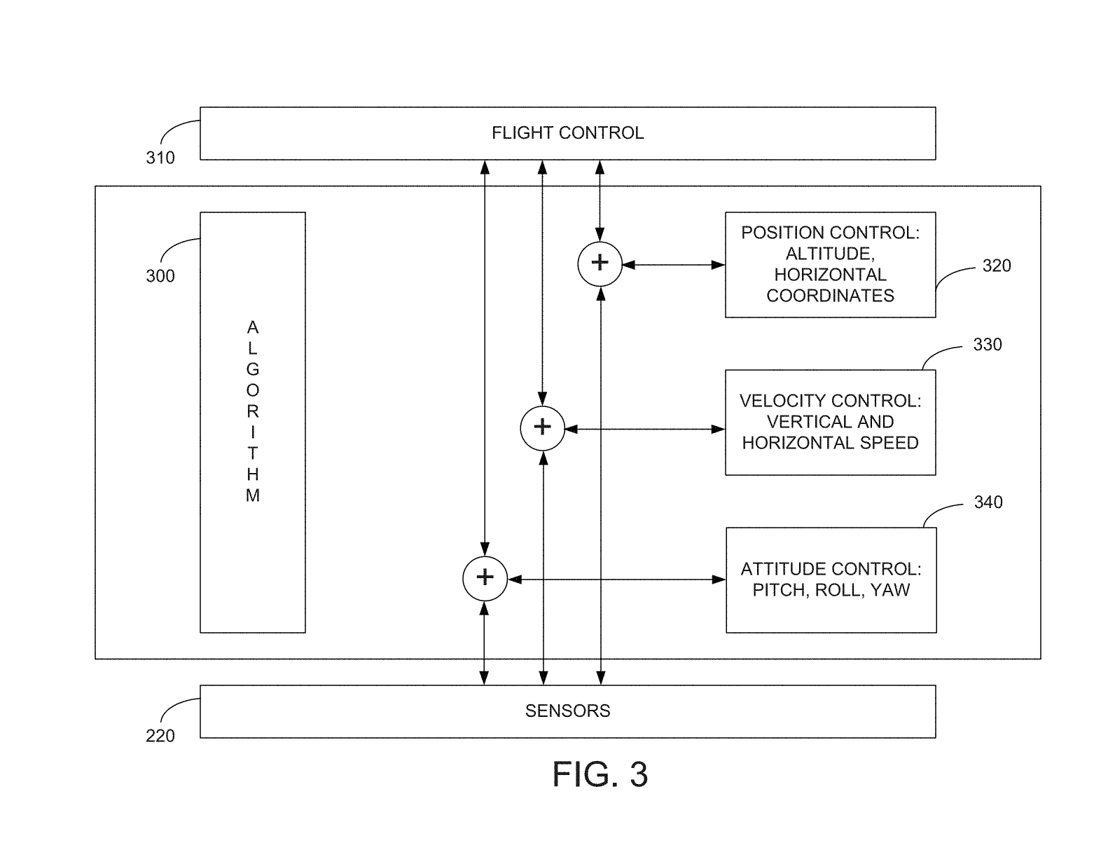

Referring to FIG. 3, the control over the flight of the UAV may be based upon control software that includes open loops to change the state of the system, like the controls to affect the position of the UAV; and/or closed loops with feedback that use sensors to measure the state of the dynamic system to affect the position of the UAV. The control software may be provided as firmware software, middleware software, operating system software, and/or control software maintained primarily within memory associated with the processor 210. Algorithms 300 may be used to facilitate a desired flight control 310 based upon data from the sensors 220 to effectuate change. The flight control 310 may include, for example, a particular flight path, trajectory generation, and trajectory regulation. The changes may include, for example, position control 320 such as altitude, and position. The changes may include, for example velocity control 330 such as vertical and horizontal speed. The changes may include, for example, attitude control 340 such as pitch, roll, and yaw.

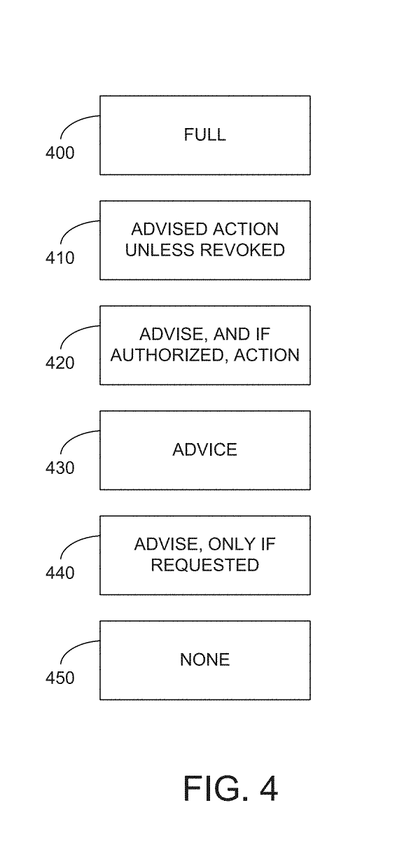

Referring to FIG. 4, depending on the firmware and the sensors and/or actuators included, the UAV may have a different amount of autonomy. For example, the processor may have full autonomy 400 to control its operation. For example, the processor may have full autonomy unless revoked 410. For example, the processor may advise and, if authorized, provide the action 420. For example, the processor may request advice 430 on its actions. For example, the processor may advise only if requested 440. For example, the processor may have no autonomy 450.

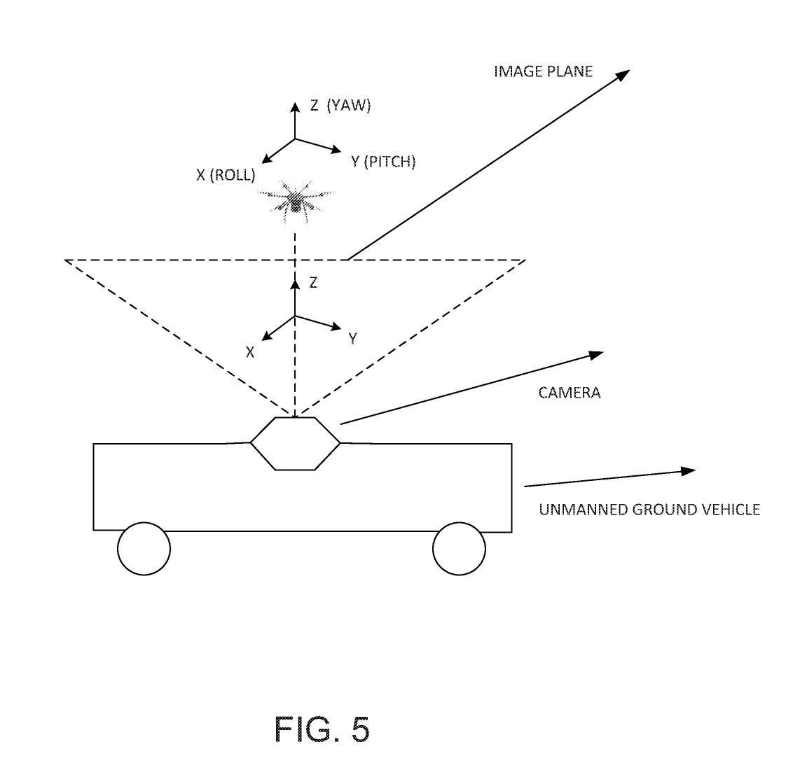

Referring to FIG. 5, in some environments, the aerial unmanned vehicle (UAV) is transported on board an unmanned ground vehicle that is suitable for performing ground functions that often pertains to surveillance and other activities. Access to all parts of a site may be limited due to natural obstacles (uneven terrain, water hazards, trees, etc.). Even at the locations the unmanned ground vehicle may access, it may have limited ability to gather data due to the location of sensors on the unmanned ground vehicle or external objects impeding data gathering. To enhance the unmanned ground vehicle's ability to gather data, the unmanned ground based control platform, generally referred to as a ground vehicle or unmanned ground vehicle, provides communication to and receives communication from, unmanned aerial vehicles. The aerial unmanned vehicles may act as an accessory to the unmanned ground vehicle. In this manner, the unmanned aerial vehicle extends the capability of the unmanned ground vehicle by providing additional functionality, such as extended visibility into areas that are challenging for the ground vehicle to observe. As previously described, the unmanned aerial vehicle traditionally relies on a plurality of sensors that provide position information (e.g., x, y, or latitude, longitude) and one or more sensors that provide orientation information (e.g., roll, pitch, yaw). These particular sensors enable a processor to determine its pose and thus provide a pose estimation of the unmanned aerial vehicle in real time to facilitate its navigation. However, these sensors on the unmanned aerial unmanned aerial vehicle add considerable weight, added computational complexity for the processor, and expense.

As illustrated in FIG. 5, it is preferable that sensors provided by the unmanned ground vehicle are utilized to provide autonomous navigation capabilities for an autonomous unmanned aerial vehicle. More specifically, the unmanned ground vehicle may use its sensors to gather positional informational and/or movement based information for the unmanned aerial vehicle, such sensors may include cameras provided with the unmanned ground vehicle. The unmanned ground vehicle processes the data from its sensors to determine a pose estimate for the unmanned aerial vehicle together with movement based information for the unmanned aerial vehicle. Based upon the pose estimation and/or the motion estimation, the unmanned ground vehicle may wirelessly provide motion control data to the unmanned aerial vehicle. The motion control data may include, for example, aileron information (e.g., roll), elevator information (e.g., pitch), rudder information (e.g., yaw), and throttle information (e.g., speed). The ground vehicle and the unmanned aerial vehicle are communicatively coupled to one another, such as through a wireless communication protocol, which is preferably bi-directional. At any given waypoint, the unmanned ground vehicle may be programmed or directed to command the unmanned aerial vehicle(s) to take off and fly to a desired location in the vicinity of the unmanned ground vehicle and perform various tasks. The unmanned aerial vehicle may be equipped with cameras and/or other imaging devices for streaming and/or collecting visual and other types of data. The actions of the unmanned aerial vehicles are controlled by the unmanned ground vehicle, which issues commands to and receives commands from the unmanned aerial vehicle using the wireless communication link. Preferably, the unmanned aerial vehicle does not include a yaw sensor, does not include a pitch sensor, does not include a roll sensor, and/or does not include a throttle sensor. Also, the unmanned aerial vehicle may further not include one or more of the other aforementioned sensors. In some cases, the unmanned ground vehicle may be controlled remotely by an operator.

To assist in the unmanned ground vehicle being capable of more readily estimating the pose of the unmanned aerial vehicle, the unmanned aerial vehicle may include one or more visual markers that may be used for determining its position (x, y, z) and orientation (roll, pitch, yaw), such as relatively to the unmanned ground vehicle. The size, scale, relatively position, and/or distortion of the markers assist in determining the unmanned aerial vehicle's position and/or orientation.

Preferably the unmanned ground vehicle, before it starts its mission, is initially configured with a ground route that it is required to navigate on in order to perform its mission. Additionally, at various points in its route it is required to stop and perform various additional actions or perform actions while still in motion, generally referred to as waypoint actions. One such waypoint action may involve the unmanned aerial vehicle that is positioned inside or on top of the unmanned ground vehicle. The waypoint action may involve the unmanned aerial vehicle to fly up to a desired height and location around the unmanned ground vehicle. The unmanned aerial vehicle may use an observational imaging device that could for example, either stream live video through the unmanned ground vehicle access point, record video content on to its internal memory, or otherwise obtain image content. The actions of the unmanned aerial vehicle may be part of the actions taken at a waypoint, generally referred to as a waypoint action. At the end of the waypoint the unmanned aerial vehicle would land on the unmanned ground vehicle landing surface, at which point the ground vehicle would resume its mission and go to its next waypoint.

As previously discussed, the unmanned aerial vehicle is preferably not equipped with sensors suitable to determine such position and movement based information. The pose estimate, the location estimation, the orientation estimation, of the unmanned aerial vehicle may be determined by an imaging device positioned on the unmanned ground vehicle that points upward to the flying aerial vehicle to determine such information. The unmanned aerial vehicle may have one or more visual markers that aids in its detection in the field of view of the imaging system on the unmanned ground vehicle. The maximum and limits of field of view of the imaging system on the unmanned ground vehicle is predetermined and is used as a “map” to specify the unmanned aerial vehicle's desired pose for surveillance and observation that is requested by the user as part of the waypoint action. More specifically, the imaging devices on the unmanned ground vehicle may track visual markers on the unmanned aerial vehicle to determine its position (x, y, z) and orientation (roll, pitch, way) relative to the unmanned ground vehicle. Also, the markers on the unmanned aerial vehicle will change in their size, scale, and distortion when detected to provide data for the location and orientation estimation. During the execution of the waypoint action the system tries to maintain or select the desired pose by sending throttle, aileron, rudder and/or elevation (e.g., throttle) commands to the unmanned aerial vehicle. The unmanned aerial vehicle receives such commands and applies them to the appropriate actuators.

As previously described, the unmanned aerial vehicle preferably takes off from and lands on the unmanned ground vehicle based upon the commands from the unmanned ground vehicle. The position and orientation of the unmanned aerial vehicle is commanded by the unmanned ground vehicle in real time through a wireless connection. Thus, the algorithms for maintaining height, location, and orientation of the unmanned aerial vehicle, and for autonomous navigation using throttle, rudder, aileron, and elevators controls are provided by the unmanned ground vehicle.

It is desirable to determine the likely accuracy of the estimations, such as the pose estimation. The accuracy may be dependent on one or more factors, such as environmental conditions. The unmanned ground vehicle may assign a confidence level to each pose estimate it determines based on the tracking data it collections, as well as the current operating conditions.

In particular, the unmanned ground vehicle may be equipped with additional sensors that provide data to arrive at a confidence level. Two such sensors may be a wind sensor and/or luminance sensor. The presence of wind and low lighting conditions, for example, tend to degrade the ability of the unmanned ground vehicle to provide an accurate pose estimate. Under certain conditions the unmanned ground vehicle may determine that it is not safe for the unmanned aerial vehicle to fly based on the confidence level. The unmanned ground vehicle may generate a confidence level value with each pose estimate it makes of the unmanned aerial vehicle. Under normal circumstances, the unmanned ground vehicle is checking the level of this confidence measure before issuing a flight command to the unmanned aerial vehicle. During active flight navigation, if the confidence falls below a certain threshold for a sufficient period of time, the unmanned ground vehicle may issue a command for the unmanned aerial vehicle to initiate emergency landing on its own or otherwise not fly or otherwise attain a safe position. In this manner, the unmanned ground vehicle may refrain from executing or completing a waypoint action involving the aerial vehicle.

The unmanned aerial vehicle may be equipped with additional low-cost sensors for improved safety, reliability and performance. In one such embodiment, the unmanned aerial vehicle is equipped with a sonar pointing downward that measures its approximately altitude. This would be a safety sensor that would be used to maintain height in the event of a failure of the vision-based detection by the camera on the unmanned ground vehicle. The unmanned aerial vehicle may be equipped with an inertial measurement unit that provides the orientation (roll, pitch, yaw) of the unmanned aerial vehicle. These and other types of sensors may provide safeguards that allow the unmanned aerial vehicle to land safely in the event of a failure of the imaging detection system or a loss of the communications link with the unmanned ground vehicle. This may also be used in conjunction with the pose estimation system on the unmanned ground vehicle to increase the confidence level and improve navigation accuracy.

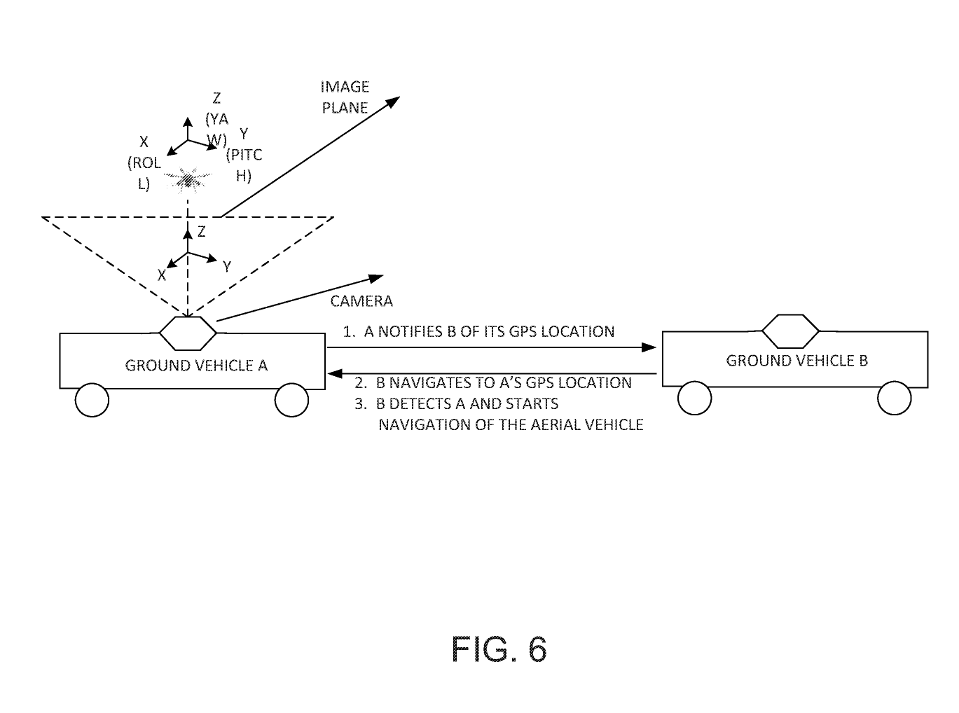

Referring to FIG. 6, another embodiment may involve the use of multiple autonomous unmanned ground vehicles that are communicatively coupled together. The unmanned aerial vehicle that is deployed and controlled by one unmanned ground vehicle may be handed off to another unmanned ground vehicle in the vicinity, without causing any disruption of operations. In this scenario, the first unmanned ground vehicle, denoted GVA, notices a second unmanned ground vehicle, denoted GVB, of the reference GPS coordinates of the unmanned aerial vehicle it is controlling. GVB autonomously drives to the specified location and attempts to locate the unmanned aerial vehicle using its imaging system. Once GVB detects the unmanned aerial vehicle and starts tracking it, it notifies GVA, which in turn informs the unmanned aerial vehicle of the handoff and passes control to GVB. Alternatively, if the unmanned aerial vehicle is equipped with navigation sensors, GVA may instruct it to simply maintain its position while GBV travels to the reported location. GVB then established contact with the unmanned aerial vehicle once it starts tracking.

In yet another embodiment, the unmanned aerial vehicles may be deployed and controlled from non-moving bases, that is, unmanned ground vehicles may not be required. In this embodiment, one or more movable or stationary bases may be set up with fixed cameras and wireless communication to track unmanned aerial vehicles. The ground bases may relay collected data to one or more non-collocated processing entities, receive commands from the processing entities for navigation of the unmanned aerial vehicles, and relay such commands to the unmanned aerial vehicles. In some embodiments, the sensor to sense the autonomous unmanned aerial vehicle may be based upon a stationary vehicle or a stationary platform. In the event that the sensor is affixed to the stationary platform, such as a vertical pole, the sensor is preferably arranged so that its sensor is oriented in an upwardly directed orientation.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method for controlling an unmanned aerial vehicle comprising:
(a) sensing said unmanned aerial vehicle using an imaging device from an unmanned ground vehicle;
(b) based upon said sensing a processor determining at least one of position information of said unmanned aerial vehicle and orientation information of said unmanned aerial vehicle;
(c) said processor providing control information through a wireless communication to said unmanned aerial vehicle for adjusting at least one of a position of said unmanned aerial vehicle and orientation of said unmanned aerial vehicle;
(d) said unmanned aerial vehicle receiving said control information and modifying control of said unmanned aerial vehicle based upon said control information, wherein said unmanned aerial vehicle is free from said modifying control based upon any inertial measurement devices within said unmanned aerial vehicle, and wherein said unmanned aerial vehicle is free from including any inertial measurement devices.

2. The method of claim 1 wherein said position information includes an offset position of said unmanned aerial vehicle from said unmanned ground vehicle.

3. The method of claim 1 wherein said position information includes a longitude and a latitude of said unmanned aerial vehicle.

4. The method of claim 1 wherein said orientation information includes a roll of said unmanned aerial vehicle.

5. The method of claim 1 wherein said orientation information includes a pitch of said unmanned aerial vehicle.

6. The method of claim 1 wherein said orientation information includes a yaw of said unmanned aerial vehicle.

7. The method of claim 1 wherein said control information is sufficient for said adjusting.

8. The method of claim 1 wherein said unmanned aerial vehicle is free from including a position sensor capable of determining position information of said unmanned aerial vehicle.

9. The method of claim 8 wherein said position sensor includes a latitude and a longitude sensor.

10-13. (canceled)

14. The method of claim 1 further comprising said based upon said sensing determining movement information of said unmanned aerial vehicle and orientation information of said unmanned aerial vehicle.

15. The method of claim 1 further comprising receiving imaging information through said wireless communication from said unmanned aerial vehicle.

16. The method of claim 1 wherein said determining said at least one of position information of said unmanned aerial vehicle and orientation information of said unmanned aerial vehicle is based upon at least one visual marker on said unmanned aerial vehicle.

17. The method of claim 16 wherein said determining is further based upon at least one of a size, a scale, and a distortion of said at least one visual marker.

18. The method of claim 1 further comprising determining a confidence level of said at least one of said position information and said orientation information.

19. The method of claim 18 based upon said confidence level providing said control information to said unmanned aerial vehicle to land.

20. The method of claim 1 further comprising said unmanned ground vehicle passing control to a second unmanned ground vehicle to provide control commands to said unmanned aerial vehicle.

21. A method for controlling an unmanned aerial vehicle comprising:
(a) sensing said unmanned aerial vehicle using an imaging device from an unmanned ground platform;
(b) based upon said sensing a processor determining at least one of position information of said unmanned aerial vehicle and orientation information of said unmanned aerial vehicle;
(c) said processor providing control information through a wireless communication to said unmanned aerial vehicle for adjusting at least one of a position of said unmanned aerial vehicle and orientation of said unmanned aerial vehicle;
(d) said unmanned aerial vehicle receiving said control information and modifying control of said unmanned aerial vehicle based upon said control information, wherein said unmanned aerial vehicle is free from said modifying control based upon any inertial measurement devices within said unmanned aerial vehicle, and wherein said unmanned aerial vehicle is free from including any inertial measurement devices.
